(19) United States
(12) Patent Application Publication
(10) Pub. No.: US 2024/0234856 A9
(43) Pub. Date: Jul. 11, 2024

(54) APPARATUS AND METHOD FOR FORMING A BATTERY CELL WITH HIGH THERMAL CONDUCTANCE FILLER MATERIAL FOR EXCELLENT THERMAL PERFORMANCE

(71) Applicant: GM GLOBAL TECHNOLOGY OPERATIONG LLC, Detroit, MI (US)

(72) Inventors: Liang Xi, Northville, MI (US); Andrew P. Oury, Troy, MI (US); Li Yang, Troy, MI (US); SriLakshmi Katar, Troy, MI (US)

(73) Assignee: GM GLOBAL TECHNOLOGY OPERATIONS LLC, Detroit, MI (US)

(21) Appl. No.: 17/969,951

(22) Filed: Oct. 20, 2022

(51) Int. Cl. H01M 10/653; H01M 10/04; H01M 50/103; H01M 50/46; H01M 50/489

(52) U.S. Cl. CPC H01M 10/653; H01M 10/049; H01M 50/103; H01M 50/46; H01M 50/489; H01M 2004/021

(57) ABSTRACT

An apparatus including a battery cell includes an electrode stack. The electrode stack includes an anode electrode, a cathode electrode, and a separator disposed between the anode electrode and the cathode electrode. The apparatus further includes an enclosure configured for encasing and mechanically protecting the electrode stack. The apparatus further includes an electrolyte. The apparatus further includes a thermally conductive and electrically insulated inert fill material located between the electrode stack and the enclosure configured for providing a thermally conductive connection between the electrode stack and the enclosure.

### INTRODUCTION

The disclosure generally relates to an apparatus and method for forming a battery cell with high thermal conductance filler material for excellent thermal performance.

A battery cell includes an anode electrode, a cathode electrode, a separator, and an electrolyte. During charging and discharging cycles, the battery cell generates heat. The battery cell has a desired operating temperature range which may include, in one example, typically from about −30° C. to about 50° C. If the battery cell operates at high temperature, for example 45° C. or higher, this may accelerate the battery cell degradation and thus reduce battery cell performance.

### SUMMARY

An apparatus including a battery cell is provided. The apparatus includes an electrode stack. The electrode stack includes an anode electrode, a cathode electrode, and a separator layer disposed between the anode electrode and the cathode electrode. The apparatus further includes an enclosure configured for encasing and mechanically protecting the electrode stack and an electrolyte. The apparatus further includes a thermally conductive and electrically insulated inert fill material located between the electrode stack and the enclosure configured for providing a thermally conductive connection between the electrode stack and the enclosure.

In some embodiments, the thermally conductive and electrically insulated inert fill material includes ceramic particles.

In some embodiments, the ceramic particles are formed from at least one of alumina oxide, silicon oxide, zeolite, lithiated zeolite, lithium lanthanum zirconium oxide, and lithium aluminum titanium phosphate.

In some embodiments, the thermally conductive and electrically insulated inert fill material further includes a polymeric binder configured for fixing a shape and location of the ceramic particles within the enclosure.

In some embodiments, the polymeric binder includes polyvinylidene fluoride, poly(vinylidene fluoride-co-hexafluoropropylene), or polytetrafluoroethylene.

In some embodiments, the ceramic particles and the polymeric binder are dissolved in an organic solvent and applied to a bottom surface of an interior defined by the enclosure.

In some embodiments, the thermally conductive and electrically insulated inert fill material is configured for scavenging and retaining moisture, hydrogen fluoride, or manganese(2+) from the electrolyte.

In some embodiments, the thermally conductive and electrically insulated inert fill material includes a polymeric binder with thermal conductivity of from 0.1 Watt per meter-Kelvin to 20 Watts per meter-Kelvin.

In some embodiments, the thermally conductive and electrically insulated inert fill material includes a solid phase change material.

In some embodiments, the thermally conductive and electrically insulated inert fill material includes a foam soaked with the electrolyte.

In some embodiments, the electrode stack includes a jellyroll electrode stack including a flexible anode electrode layer, a flexible cathode electrode layer, and a flexible separator layer disposed between the flexible anode electrode layer and the flexible cathode electrode layer. The flexible anode electrode layer, the flexible cathode electrode layer, and the flexible separator layer are disposed in a rolled configuration, such that a swirl pattern is created on two distal ends of the jellyroll electrode stack.

In some embodiments, the electrode stack includes a plurality of anode electrode and cathode electrode pairs, wherein each of the anode electrode and cathode electrode pairs includes a separator disposed therebetween.

In some embodiments, the apparatus is a prismatic battery cell, and the enclosure includes a rectangular can.

In some embodiments, the enclosure includes a cylindrical outer surface, an oval-racetrack-shaped outer surface, or a flexible pouch.

In some embodiments, the enclosure defines an inner recess configured for receiving the electrode stack and including a bottom surface, a plurality of side wall surfaces, and a top surface. The thermally conductive and electrically insulated inert fill material is disposed between the bottom surface and the electrode stack.

In some embodiments, the enclosure defines an inner recess configured for receiving the electrode stack and including a bottom surface, a plurality of side wall surfaces, and a top surface. The thermally conductive and electrically insulated inert fill material is disposed between one of the plurality of side wall surfaces and the electrode stack.

In some embodiments, the enclosure defines an inner recess configured for receiving the electrode stack and including a bottom surface, a plurality of side wall surfaces, and a top surface. The thermally conductive and electrically insulated inert fill material is disposed between a first of the plurality of side wall surfaces and the electrode stack and between a second of the plurality of side wall surfaces and the electrode stack.

In some embodiments, the enclosure defines an inner recess configured for receiving the electrode stack and including a bottom surface, a plurality of side wall surfaces, and a top surface. The thermally conductive and electrically insulated inert fill material is disposed between the top surface and the electrode stack.

In some embodiments, the enclosure defines an inner recess configured for receiving the electrode stack and including a bottom surface, a plurality of side wall surfaces, and a top surface. The thermally conductive and electrically insulated inert fill material is disposed between the top surface and the electrode stack and between the bottom surface and the electrode stack.

According to one alternative embodiment, a method for forming a battery cell is provided. The method includes disposing an electrode stack within an enclosure configured for mechanically protecting the electrode stack. The method further includes disposing a thermally conductive and electrically insulated inert fill material between the electrode stack and the enclosure, wherein the thermally conductive and electrically insulated inert fill material is configured for providing a thermally conductive connection between the electrode stack and the enclosure. The method further includes disposing a liquid electrolyte within the enclosure.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates in front view a battery cell and cooling plate configuration including a battery cell and a cooling plate, in accordance with the present disclosure;

FIGS. 2-7 schematically illustrate in side view embodiments of battery cells including different locations in which the thermally conductive and electrically insulated inert fill material may be disposed within the battery cells, in accordance with the present disclosure;

FIG. 2 schematically illustrates the battery cell of FIG. 1 including a thermally conductive and electrically insulated inert fill material disposed between one of the sidewall surfaces and a side surface of the electrode stack, in accordance with the present disclosure;

FIG. 3 schematically illustrates the battery cell of FIG. 1 including a thermally conductive and electrically insulated inert fill material disposed between one of the sidewall surfaces and the side surface of the electrode stack, in accordance with the present disclosure;

FIG. 4 schematically illustrates the battery cell of FIG. 1 including the thermally conductive and electrically insulated inert fill material disposed between one of the sidewall surfaces and the side surface of the electrode stack and a thermally conductive and electrically insulated inert fill material disposed between another one of the sidewall surfaces and a second side surface of the electrode stack, in accordance with the present disclosure;

FIG. 5 schematically illustrates the battery cell of FIG. 1 including a thermally conductive and electrically insulated inert fill material disposed between the top surface and a top surface of the electrode stack, in accordance with the present disclosure;

FIG. 6 schematically illustrates the battery cell of FIG. 1 and a thermally conductive and electrically insulated inert fill material disposed between the top surface and a top surface of the electrode stack, in accordance with the present disclosure;

FIG. 7 schematically illustrates the battery cell of FIG. 1 and a thermally conductive and electrically insulated inert fill material disposed between the top surface and the top surface of the electrode stack and a thermally conductive and electrically insulated inert fill material disposed between the bottom surface and a bottom surface of the electrode stack, in accordance with the present disclosure;

FIG. 8 schematically illustrates the battery cell of FIG. 1 which is a prismatic battery cell including the enclosure embodied as a polyhedral, rectangularly shaped can, in accordance with the present disclosure;

FIG. 9 schematically illustrates a battery cell of FIG. 1 which is a pouch battery cell including an enclosure embodied as a flexible foil outer shell, in accordance with the present disclosure;

FIG. 10 schematically illustrates a battery cell of FIG. 1 which is a prismatic battery cell including an enclosure embodied as a cylindrically shaped can, in accordance with the present disclosure;

FIG. 11 schematically illustrates a battery cell of FIG. 1 which is a prismatic battery cell including an enclosure embodied as a polyhedral can with an oval-racetrack-shape, in accordance with the present disclosure;

FIG. 12 is a flowchart illustrating a method for forming a battery cell, in accordance with the present disclosure; and

FIG. 13 is a graph illustrating a relationship between a temperature gradient contour of the battery cell and cooling plate configuration of FIG. 1, in accordance with the present disclosure.

### DETAILED DESCRIPTION

A battery cell includes an electrode stack. The electrode stack includes one or more anode electrodes, one or more cathode electrodes, and separators separating each of the anode electrodes from each of the cathode electrodes. An electrode stack may include a plurality of flat plates. An electrode stack may include a jellyroll electrode stack, which may include a flexible anode electrode, a flexible cathode electrode, and a flexible separator. The flexible anode electrode, the flexible cathode electrode, and the flexible separator may be rolled into a cylindrical shape, wherein layers of the electrodes and the separator appear as a swirl pattern on two ends of the cylindrical shape. In another embodiment, the jellyroll electrode may be flattened into an oval or an O-shaped racetrack shape.

The battery cell may be a prismatic battery cell with a hard outer case or can configured for containing and mechanically protecting the electrode stack within the case. The can may be metallic, plastic, a polymer, or other similar materials. A battery cell may be a pouch cell, with a flexible outer shell. The flexible outer shell may be constructed with a metallic foil.

A battery cell generates heat when operating in a charging cycle or a discharging cycle. In order to maintain a desired operating temperature range within the battery cell, heat may be transferred away from the battery cell. A cooling plate may be disposed in contact with an outside surface of the battery cell to conduct heat away from the battery cell. Heat is generated within the battery cell within the electrode stack by an electrochemical reaction taking place between the anode electrode(s) and the cathode electrode(s). In order for heat to be transferred from the electrode stack to the cooling plate, heat may be transferred from the electrode stack to the can or flexible outer shell that is used to contain the electrode stack. A heat transfer path with high thermal conductance between the electrode stack and the can or flexible outer shell of the battery cell provides excellent heat transfer and an ability to maintain a desired operating temperature range within the battery cell.

The battery cell may include a liquid electrolyte or a solid-state electrolyte. A liquid electrolyte may provide a heat transfer path from the electrode stack to the can or the flexible outer shell when present. However, liquid electrolyte may become scarce within the battery cell due to electrolyte dry out as the battery cell cycles. A gap may exist between the electrode stack and the can or the flexible outer shell. A gap may provide low thermal conductance or may inhibit efficient heat transfer between the electrode stack and the can or the flexible outer shell.

An apparatus and method for forming a battery cell are provided. The apparatus includes an electrode stack. The electrode stack includes an anode electrode, a cathode electrode, and a separator layer disposed between the flexible anode electrode layer and the flexible cathode electrode layer. The apparatus further includes an enclosure configured for encasing and mechanically protecting the electrode stack. The apparatus further includes a thermally conductive and electrically insulated inert fill material located between the electrode stack and the enclosure configured for providing a thermally conductive connection between the electrode stack and the outer shell.

The thermally conductive and electrically insulated inert fill material provides a heat transfer path with high thermal conductance between the electrode stack and the can or flexible outer shell of the battery cell. The thermally conductive and electrically insulated inert fill material is electrically insulating, meaning that the thermally conductive and electrically insulated inert fill material does not provide an electrically conductive path between the anode electrode and the cathode electrode or between the electrode stack and the enclosure. In one embodiment, the thermally conductive and electrically insulated inert fill material includes ceramic particles. The ceramic particles may be formed from at least one of alumina or aluminum oxide (Al₂O₃), silicon oxide such as silicon dioxide (SiO₂), lithiated zeolite, lithium lanthanum zirconium oxide (LLZO), or lithium aluminum titanium phosphate (LATP). In one embodiment, the thermally conductive and electrically insulated inert fill material may be described as including a thermal conductivity in a range from 0.1 Watt per meter-Kelvin and 20 Watts per meter-Kelvin.

The thermally conductive and electrically insulated inert fill material may include a polymeric binder configured for fixing a shape and location of the ceramic particles within the enclosure. The polymeric binder may include polyvinylidene fluoride, poly(vinylidene fluoride-co-hexafluoropropylene), or polytetrafluoroethylene. The ceramic particles and the polymeric binder are dissolved in an organic solvent and applied to a bottom surface of an interior of the enclosure.

The thermally conductive and electrically insulated inert fill material may be configured for scavenging and retaining moisture, hydrogen fluoride, or manganese(2+) from the liquid electrolyte.

The thermally conductive and electrically insulated inert fill material may include a polymeric binder with a thermal conductivity of from 0.1 Watt per meter-Kelvin and 20 Watts per meter-Kelvin.

The thermally conductive and electrically insulated inert fill material may include a solid phase change material.

The thermally conductive and electrically insulated inert fill material includes a foam soaked with the liquid electrolyte.

The electrode stack may include a jellyroll electrode stack including a flexible anode electrode layer, a flexible cathode electrode layer, and a flexible separator layer disposed between the flexible anode electrode layer and the flexible cathode electrode layer. The flexible anode electrode layer, the flexible cathode electrode layer, and the flexible separator layer are disposed in a rolled configuration, such that a swirl pattern is created on two distal ends of the jellyroll electrode stack.

The electrode stack may include a plurality of anode electrode and cathode electrode pairs, wherein each of the anode electrode and cathode electrode pairs includes a separator disposed therebetween.

The apparatus may include a prismatic battery cell. The enclosure includes a rectangular can.

In some embodiments, the enclosure may include a cylindrical outer surface, an oval-racetrack-shaped outer surface, or a flexible pouch.

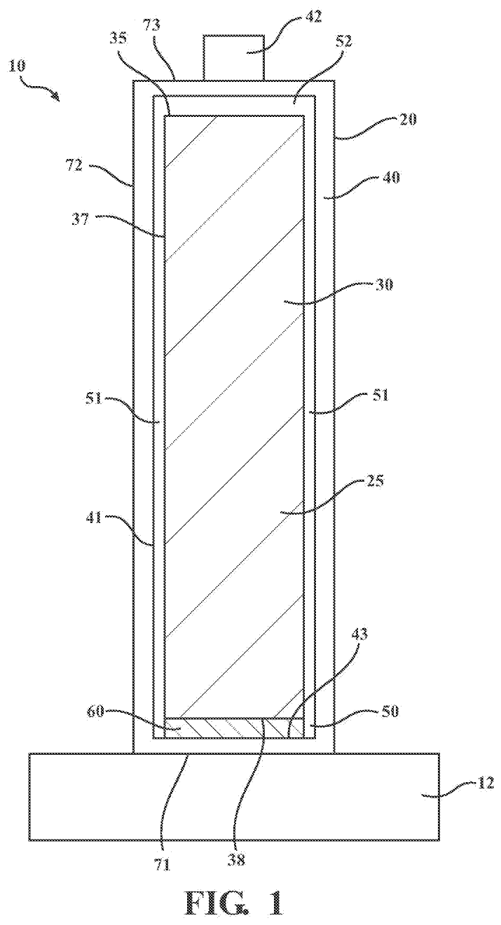

Referring now to the drawings, wherein like reference numbers refer to like features throughout the several views, FIG. 1 schematically illustrates a battery cell and cooling plate configuration 10 including a battery cell 20 and a cooling plate 12. The cooling plate 12 may include thermally conductive materials, may include a liquid coolant loop, and other structures in the art for transferring heat away from a surface or area. The cooling plate 12 is illustrated disposed next to or abutting a bottom surface 71 of the battery cell 20. In other embodiments, the cooling plate 12 may additionally or alternatively abut one or more side surfaces 72 of the battery cell 20 and/or a top surface 73 of the battery cell 20. The battery cell 20 includes an electrode stack 30, an electrolyte 25, and an enclosure 40. The electrode stack 30 may be a plurality of electrode plates including a plurality of pairs of anode electrodes and cathode electrodes, with each pair being separate by a separator. A liquid electrolyte may be present within the electrode stack 30. One or more tabs 42 may be provided as a battery cell terminal.

A gap 50 may exist between a bottom surface 38 of the electrode stack 30 and the enclosure 40. A gap 51 may exist between the enclosure 40 and a side 37 of the electrode stack 30. A gap 52 may exist between a top 35 of the electrode stack 30 and the enclosure 40. The gaps 50, 51, 52 provide relatively poor thermal conductivity as compared to the electrode stack 30 directly contacting the enclosure 40. As a result, inefficient heat transfer between the electrode stack 30 and the enclosure 40 may result from the presence of the gaps 50, 51, 52.

A thermally conductive and electrically insulated inert fill material 60 is provided to fill the gap 50 and provide a heat transfer path with high thermal conductance between the electrode stack 30 and the enclosure 40. The thermally conductive and electrically insulated inert fill material 60 disposed between a bottom surface 43 within an internal recess 41 of the enclosure 40 and a bottom surface 38 of the electrode stack 30. The thermally conductive and electrically insulated inert fill material 60 may be utilized within one or more of the gaps 50, 51, 52. In one embodiment, the thermally conductive and electrically insulated inert fill material 60 may be disposed in contact with a portion of the enclosure 40 that also abuts the cooling plate 12 to provide excellent heat transfer from the electrode stack 30, through the thermally conductive and electrically insulated inert fill material 60, through the enclosure 40, and to the cooling plate 12.

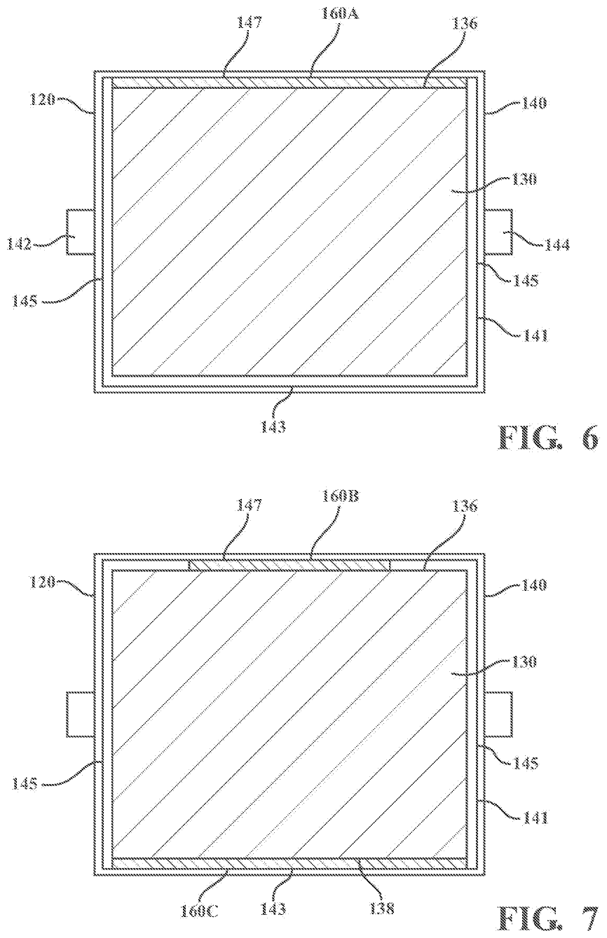

FIGS. 2-7 schematically illustrate embodiments of battery cells 20, 120 including different locations in which the thermally conductive and electrically insulated inert fill material 60 may be disposed within the enclosure 40, 140 of the battery cells 20, 120. FIGS. 2-5 illustrate the battery cell 20 including two tabs 42, 44 located upon a top surface 47 of the battery cell 20. The battery cell 20 includes the internal recess 41 including the bottom surface 43, sidewall surfaces 45, and a top surface 47. FIGS. 6 and 7 illustrate the battery cell 120 including two tabs 142, 144 located upon two sidewall surfaces of the battery cell 120. The battery cell 120 includes an internal recess 141 including a bottom surface 143, sidewall surfaces 145, and a top surface 147.

FIG. 2 schematically illustrates the battery cell 20 including a thermally conductive and electrically insulated inert fill material 60A disposed between one of the sidewall surfaces 45 and a side surface 32 of the electrode stack 30. The thermally conductive and electrically insulated inert fill material 60A covers an entirety of the side surface 32.

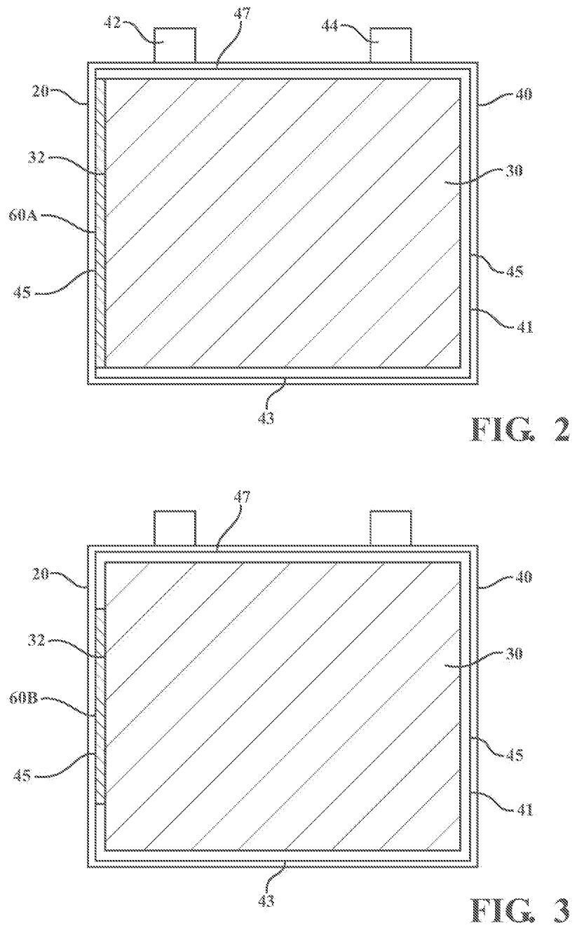

FIG. 3 schematically illustrates the battery cell 20 including a thermally conductive and electrically insulated inert fill material 60B disposed between one of the sidewall surfaces 45 and the side surface 32 of the electrode stack 30. The thermally conductive and electrically insulated inert fill material 60B covers a portion of the side surface 32.

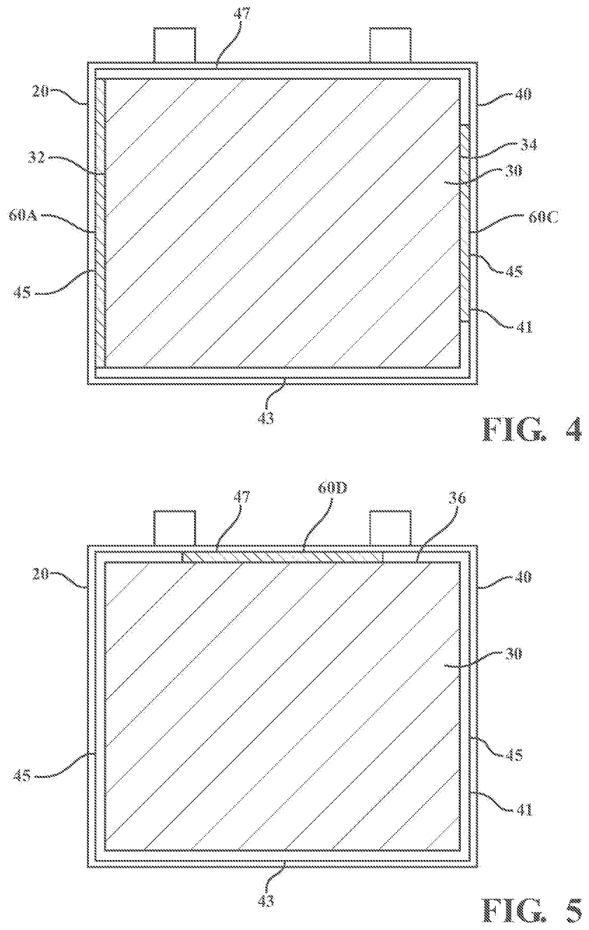

FIG. 4 schematically illustrates the battery cell 20 including the thermally conductive and electrically insulated inert fill material 60A disposed between one of the sidewall surfaces 45 and the side surface 32 of the electrode stack 30 and a thermally conductive and electrically insulated inert fill material 60C disposed between another one of the sidewall surfaces 45 and a second side surface 34 of the electrode stack 30.

FIG. 5 schematically illustrates the battery cell 20 including a thermally conductive and electrically insulated inert fill material 60D disposed between the top surface 47 and a top surface 36 of the electrode stack 30.

FIG. 6 schematically illustrates the battery cell 120 and a thermally conductive and electrically insulated inert fill material 160A disposed between the top surface 147 and a top surface 136 of the electrode stack 130.

FIG. 7 schematically illustrates the battery cell 120 and a thermally conductive and electrically insulated inert fill material 160B disposed between the top surface 147 and the top surface 136 of the electrode stack 130 and a thermally conductive and electrically insulated inert fill material 160C disposed between the bottom surface 143 and a bottom surface 138 of the electrode stack 130. The embodiments of FIGS. 2-7 are examples of locations in which the thermally conductive and electrically insulated inert fill materials 60A, 60B, 60C, 60D, 160A, 160B, 160C may be disposed within the battery cell 20, 120. Other locations and embodiments are envisioned, and the disclosure is not intended to be limited to the examples provided.

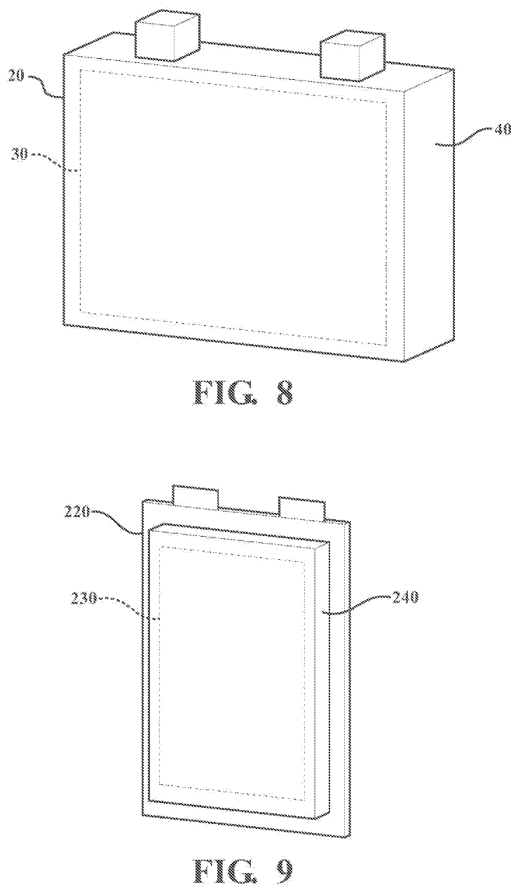

The thermally conductive and electrically insulated inert fill materials 60A, 60B, 60C, 60D, 160A, 160B, 160C of FIGS. 2-7 may be utilized in different battery cell configurations. FIG. 8 schematically illustrates the battery cell 20 of FIG. 1 which is a prismatic battery cell including the enclosure 40 embodied as a polyhedral, rectangularly shaped can. The electrode stack 30 is disposed within the enclosure 40, and one or more of the thermally conductive and electrically insulated inert fill materials 60, 60A, 60B, 60C, 60D, 160A, 160B, 160C of FIGS. 1-7 is present within the enclosure 40 providing excellent thermal conductivity between the electrode stack 30 and the enclosure 40.

FIG. 9 schematically illustrates a battery cell 220 which is a pouch battery cell including an enclosure 240 embodied as a flexible foil outer shell. An electrode stack 230 is disposed within the enclosure 240, and one or more of the thermally conductive and electrically insulated inert fill materials 60, 60A, 60B, 60C, 60D, 160A, 160B, 160C of FIGS. 1-7 is present within the enclosure 240 providing excellent thermal conductivity between the electrode stack 230 and the enclosure 240.

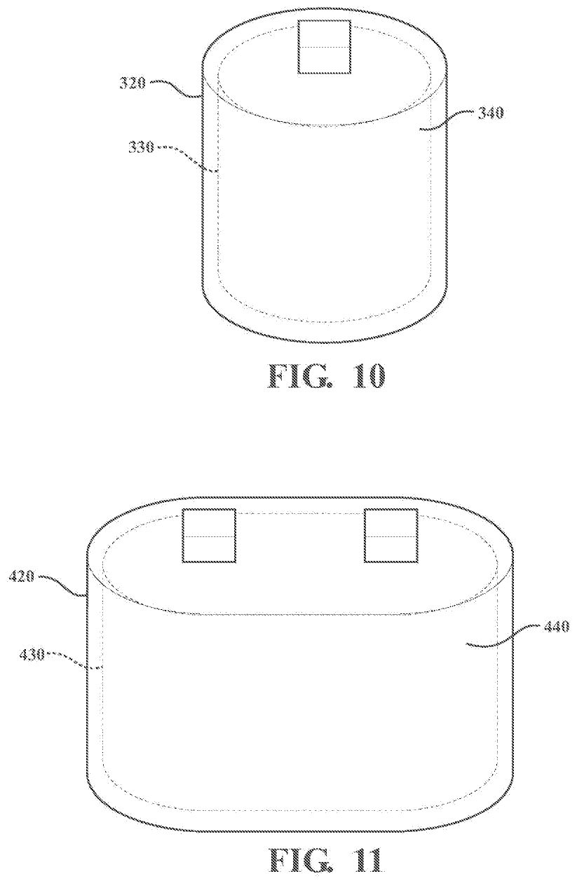

FIG. 10 schematically illustrates a battery cell 320 which is a prismatic battery cell including an enclosure 340 embodied as a cylindrically shaped can. An electrode stack 330 is disposed within the enclosure 340 and may include a cylindrically shaped jellyroll electrode stack. One or more of the thermally conductive and electrically insulated inert fill materials 60, 60A, 60B, 60C, 60D, 160A, 160B, 160C of FIGS. 1-7 is present within the enclosure 340 providing excellent thermal conductivity between the electrode stack 330 and the enclosure 340.

FIG. 11 schematically illustrates a battery cell 420 of FIG. 1 which is a prismatic battery cell including an enclosure 440 embodied as a polyhedral can with an oval-racetrack-shape. An electrode stack 430 is disposed within the enclosure 440 and may be an oval or racetrack shaped jellyroll electrode. One or more of the thermally conductive and electrically insulated inert fill materials 60, 60A, 60B, 60C, 60D, 160A, 160B, 160C of FIGS. 1-7 is present within the enclosure 440 providing excellent thermal conductivity between the electrode stack 430 and the enclosure 440.

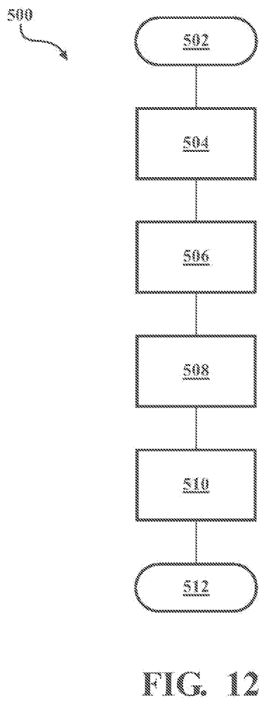

FIG. 12 is a flowchart illustrating a method 500 for forming a battery cell 20. The method 500 is described in relation to the battery cell and cooling plate configuration 10 of FIG. 1. The method 500 may be utilized similarly with other battery cell and cooling device configurations. The method 500 starts at step 502. At step 504, the thermally conductive and electrically insulated inert fill material 60 is disposed to or deposited upon a portion of the internal recess 41 of the enclosure 40. At step 506, the electrode stack 30 is placed within the enclosure 40 and the thermally conductive and electrically insulated inert fill material 60 is between the electrode stack 30 and the enclosure 40. At step 508, a liquid electrolyte is disposed within the enclosure 40 and in contact with the electrode stack 30. At step 510, the battery cell 20 is utilized to provide electrical energy to a device or system, such as a vehicle, a motor providing an output torque to a vehicle, a power generation system, a boat, or an airplane. As the electrical energy is provided, heat is transferred from the electrode stack 30, through the thermally conductive and electrically insulated inert fill material 60, through the enclosure 40, and into the cooling plate 12 such that an operating temperature range of the battery cell 20 may be maintained. The method 500 ends at step 512. The method 500 is exemplary, and a number of additional or alternative method steps are envisioned. The disclosure is not intended to be limited to the examples provided.

A method for forming a battery cell is provided. The method includes disposing an electrode stack within an enclosure configured for mechanically protecting the electrode stack. The method further includes disposing a thermally conductive and electrically insulated inert fill material between the electrode stack and the enclosure, wherein the thermally conductive and electrically insulated inert fill material is configured for providing a thermally conductive connection between the electrode stack and the enclosure. The method further includes disposing a liquid electrolyte within the enclosure.

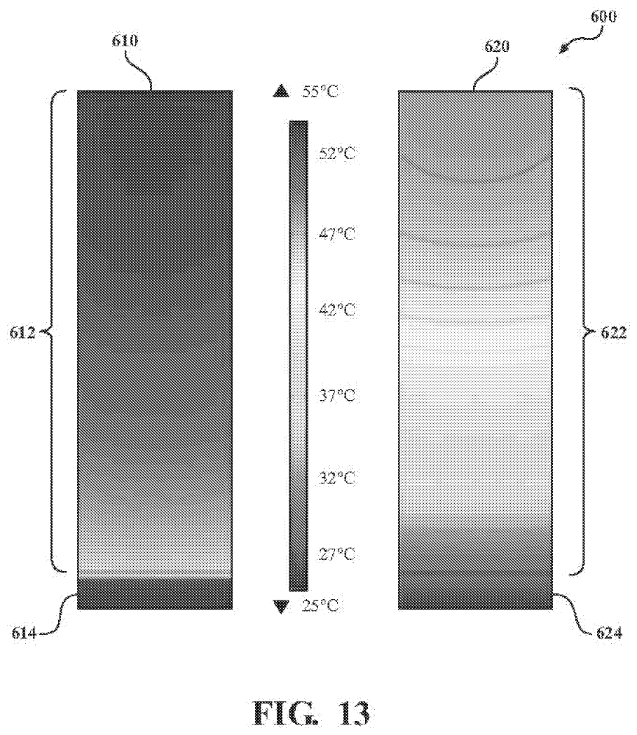

FIG. 13 is a graph 600 illustrating a relationship between a temperature gradient contour of the battery cell and cooling plate configuration 10 of FIG. 1. The graph 600 includes a first portion 610 describing temperature variation across the battery cell 20 when the thermally conductive and electrically insulated inert fill material 60 is not present and a gap exists between the battery cell 20 and the enclosure 40. The region 612 describes temperatures within the battery cell 20, with data illustrated at a bottom of the region 612 illustrating a temperature near a bottom of the battery cell 20 and with data illustrated at a top of the region 612 illustrating temperature distal from the bottom of the battery cell 20. Data at region 614 illustrates a temperature of the cooling plate 12. The data in region 612 illustrates negligible temperature change through the battery cell 20, indicating that little heat is being transferred away from the battery cell 20. The gap between the battery cell 20 and the enclosure 40 is preventing heat from being transferred from the battery cell 20 to the cooling plate 12.

The graph 600 includes a second portion 620 describing temperature variation across the battery cell 20 when the thermally conductive and electrically insulated inert fill material 60 is disposed between the battery cell 20 and the enclosure 40. The region 622 describes temperatures within the battery cell 20, with data illustrated at a bottom of the region 622 illustrating a temperature near a bottom of the battery cell 20 and with data illustrated at a top of the region 622 illustrating temperature distal from the bottom of the battery cell 20. Data at region 624 illustrates a temperature of the cooling plate 12. The data in region 622 illustrates substantial and significant temperature change through the battery cell 20, with higher temperature values distal from the cooling plate 12 steadily decreasing to lower temperature values close to the cooling plate 12, indicating that a significant amount of heat is being transferred away from the battery cell 20. The thermally conductive and electrically insulated inert fill material 60 is providing a heat transfer path including high thermal conductivity between the electrode stack 30 and the enclosure 40, enabling significant heat transfer from the electrode stack 30 to the cooling plate 12.

While the best modes for carrying out the disclosure have been described in detail, those familiar with the art to which this disclosure relates will recognize various alternative designs and embodiments for practicing the disclosure within the scope of the appended claims.

What is claimed is:

1. An apparatus including a battery cell, the apparatus comprising:
an electrode stack, including:
an anode electrode;
a cathode electrode; and
a separator layer disposed between the anode electrode and the cathode electrode;
an enclosure configured for encasing and mechanically protecting the electrode stack;
an electrolyte; and
a thermally conductive and electrically insulated inert fill material located between the electrode stack and the enclosure configured for providing a thermally conductive connection between the electrode stack and the enclosure.

2. The apparatus of claim 1, wherein the thermally conductive and electrically insulated inert fill material includes ceramic particles.

3. The apparatus of claim 2, wherein the ceramic particles are formed from at least one of alumina oxide, silicon oxide, zeolite, lithiated zeolite, lithium lanthanum zirconium oxide, and lithium aluminum titanium phosphate.

4. The apparatus of claim 2, wherein the thermally conductive and electrically insulated inert fill material further includes a polymeric binder configured for fixing a shape and location of the ceramic particles within the enclosure.

5. The apparatus of claim 4, wherein the polymeric binder includes polyvinylidene fluoride, poly(vinylidene fluoride-co-hexafluoropropylene), or polytetrafluoroethylene.

6. The apparatus of claim 4, wherein the ceramic particles and the polymeric binder are dissolved in an organic solvent and applied to a bottom surface of an interior defined by the enclosure.

7. The apparatus of claim 1, wherein the thermally conductive and electrically insulated inert fill material is configured for scavenging and retaining moisture, hydrogen fluoride, or manganese(2+) from the electrolyte.

8. The apparatus of claim 1, wherein the thermally conductive and electrically insulated inert fill material includes a polymeric binder with thermal conductivity of from 0.1 Watt per meter-Kelvin to 20 Watts per meter-Kelvin.

9. The apparatus of claim 1, wherein the thermally conductive and electrically insulated inert fill material includes a solid phase change material.

10. The apparatus of claim 1, wherein the thermally conductive and electrically insulated inert fill material includes a foam soaked with the electrolyte.

11. The apparatus of claim 1, wherein the electrode stack includes a jellyroll electrode stack including:
a flexible anode electrode layer;
a flexible cathode electrode layer; and
a flexible separator layer disposed between the flexible anode electrode layer and the flexible cathode electrode layer, wherein the flexible anode electrode layer, the flexible cathode electrode layer, and the flexible separator layer are disposed in a rolled configuration, such that a swirl pattern is created on two distal ends of the jellyroll electrode stack.

12. The apparatus of claim 1, wherein the electrode stack includes a plurality of anode electrode and cathode electrode pairs, wherein each of the anode electrode and cathode electrode pairs includes a separator disposed therebetween.

13. The apparatus of claim 1, wherein the apparatus is a prismatic battery cell; and
wherein the enclosure includes a rectangular can.

14. The apparatus of claim 1, wherein the enclosure includes a cylindrical outer surface, an oval-racetrack-shaped outer surface, or a flexible pouch.

15. The apparatus of claim 1, wherein the enclosure defines an inner recess configured for receiving the electrode stack and including a bottom surface, a plurality of side wall surfaces, and a top surface; and
wherein the thermally conductive and electrically insulated inert fill material is disposed between the bottom surface and the electrode stack.

16. The apparatus of claim 1, wherein the enclosure defines an inner recess configured for receiving the electrode stack and including a bottom surface, a plurality of side wall surfaces, and a top surface; and
wherein the thermally conductive and electrically insulated inert fill material is disposed between one of the plurality of side wall surfaces and the electrode stack.

17. The apparatus of claim 1, wherein the enclosure defines an inner recess configured for receiving the electrode stack and including a bottom surface, a plurality of side wall surfaces, and a top surface; and
wherein the thermally conductive and electrically insulated inert fill material is disposed between a first of the plurality of side wall surfaces and the electrode stack and between a second of the plurality of side wall surfaces and the electrode stack.

18. The apparatus of claim 1, wherein the enclosure defines an inner recess configured for receiving the electrode stack and including a bottom surface, a plurality of side wall surfaces, and a top surface; and
wherein the thermally conductive and electrically insulated inert fill material is disposed between the top surface and the electrode stack.

19. The apparatus of claim 1, wherein the enclosure defines an inner recess configured for receiving the electrode stack and including a bottom surface, a plurality of side wall surfaces, and a top surface; and
wherein the thermally conductive and electrically insulated inert fill material is disposed between the top surface and the electrode stack and between the bottom surface and the electrode stack.

20. A method for forming a battery cell, the method comprising:
disposing an electrode stack within an enclosure configured for mechanically protecting the electrode stack;
disposing a thermally conductive and electrically insulated inert fill material between the electrode stack and the enclosure, wherein the thermally conductive and electrically insulated inert fill material is configured for providing a thermally conductive connection between the electrode stack and the enclosure; and
disposing a liquid electrolyte within the enclosure.
